(19) United States
(12) Patent Application Publication
(10) Pub. No.: US 2026/0070168 A1
(43) Pub. Date: Mar. 12, 2026

(54) FASTENING ASSISTANCE SYSTEM

(71) Applicant: HYUNDAI MOBIS CO., LTD., Seoul (KR)

(72) Inventors: Chan Kyu KIM, Yongin-si (KR); Ki Nyeon KIM, Yongin-si (KR); Kyeong Kyu PARK, Yongin-si, Gyeonggi-do (KR); Jae In KIM, Yongin-si (KR); Sang Woo HA, Yongin-si (KR); Soon Jong CHO, Yongin-si (KR); Do Hyun KIM, Yongin-si (KR); Jae Mu EOM, Yongin-si (KR); Hyun Wook JIN, Yongin-si (KR); Young Kyu HAN, Yongin-si (KR); Hyeoung Ju KIM, Yongin-si (KR); Woo Jin KWON, Yongin-si (KR); Se Youn CHO, Yongin-si (KR); Jin Seob NOH, Yongin-si (KR); Kang Sik SHIN, Yongin-si (KR); Dong Hyung CHOI, Yongin-si (KR); Nam Hoon KIM, Yongin-si (KR); Won Gil JEONG, Yongin-si (KR); Geon Woo KIM, Yongin-si (KR); Wang Ju KIM, Yongin-si (KR)

(73) Assignee: HYUNDAI MOBIS CO., LTD., Seoul (KR)

(21) Appl. No.: 18/961,255

(22) Filed: Nov. 26, 2024

(30) Foreign Application Priority Data
Sep. 11, 2024 (KR) 10-2024-0124099

(51) Int. Cl. B23P 19/06

(52) U.S. Cl. CPC B23P 19/06

(57) ABSTRACT

The present invention relates to a fastening assistance system capable of supplying a bolt to be fastened to an object at a high speed without power regardless of a shape and a size thereof. A fastening assistance system includes an ejecting/feeding device that receives a plurality of bolts from an outside and ejects the plurality of received bolts to the outside, and a fixing device that fixes the bolts ejected from the ejecting/feeding device, wherein the ejecting/feeding device includes a control module that controls movement amounts of the plurality of bolts so that the plurality of bolts are individually ejected.

### CROSS-REFERENCE TO RELATED APPLICATION

This application claims priority to and the benefit of Korean Patent Application No. 10-2024-0124099 filed on Sep. 11, 2024, the disclosure of which is incorporated herein by reference in its entirety.

### BACKGROUND

### 1. Field of the Invention

The present invention relates to a fastening assistance system for supplying a bolt to be fastened to an object.

### 2. Discussion of Related Art

In recent years, the need to build a high-speed fastening system through automation facilities is increasing due to an increase in a process for bolt fastening and an increase in the number of locations for bolt fastening in production lines that manufacture components or devices. Here, a bolt used to be fastened to an object has various shapes and various sizes. Thus, there is a difficulty in that each fastening system is provided in an area for the bolt to be fastened. This difficulty may lead to an increase in a process time and an increase in a process cost and thus may cause a decrease in productivity.

Further, the recent fastening systems use power sources to supply bolts having various shapes and various sizes at a high speed. This may mean an increase in power consumption and an increase in process costs. Thus, the need for a system that may supply a bolt at a high speed without power regardless of the shape of the bolt and the size of the bolt is increasing.

### SUMMARY OF THE INVENTION

The present invention is directed to providing a fastening assistance system capable of supplying a bolt to be fastened to an object at a high speed without power regardless of a shape and a size thereof.

A fastening assistance system includes an ejecting/feeding device that receives a plurality of bolts from an outside and ejects the plurality of received bolts to the outside, and a fixing device that fixes the bolts ejected from the ejecting/feeding device, wherein the ejecting/feeding device includes a control module that controls movement amounts of the plurality of bolts so that the plurality of bolts are individually ejected.

The ejecting/feeding device may include a housing that accommodates the plurality of bolts therein and arranges the plurality of bolts accommodated therein, and the control module may include a pin unit that separates a frontmost bolt of the plurality of bolts accommodated in the housing from the plurality of remaining bolts.

The pin unit may be disposed at a location at which the pin unit passes through the housing.

A first moving space, in which a head of a bolt is moved, and a second moving space, which is connected to the first moving space and in which a body of a bolt is moved, may be formed in the housing of the ejecting/feeding device, and the pin unit may be moved in the second moving space.

The pin unit of the control module may include a first pin that prevents movement of the plurality of remaining bolts except for the frontmost bolt of the plurality of bolts arranged in the housing.

The pin unit of the control module may include a second pin that is disposed in front of the first pin in a direction in which the bolt is moved and controls movement of the frontmost bolt separated from the plurality of bolts by the first pin.

The control module may include a guide unit that is coupled to the pin unit and guides a movement direction of the pin unit, and a first actuating assembly that is supported by the housing and moves the guide unit, and the first pin and the second pin of the pin unit may be simultaneously moved by the first actuating assembly while being supported by the guide unit.

The fixing device may include a receiving module that accommodates the bolt ejected through the control module of the ejecting/feeding device, and a holding module that holds the bolt seated on the receiving module.

The receiving module may include a receiving plate that supports the bolt ejected to the outside of the housing of the ejecting/feeding device, and a second actuating assembly that moves the receiving plate, and the ejecting/feeding device may be disposed to be inclined in a movement direction of the receiving plate.

The holding module of the fixing device may include a clamping module including a first biting block and a second biting block that clamp the bolt seated on the receiving plate of the receiving module, and a third actuating assembly that moves the first biting block and the second biting block of the clamping module in different directions.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a plan perspective view of a fastening assistance system according to an embodiment of the present invention;

FIG. 2 is a bottom perspective view of the fastening assistance system according to the embodiment of the present invention;

FIG. 3 is an exploded perspective view of an ejecting/feeding device;

FIG. 4 is an exploded perspective view of a housing of the ejecting/feeding device;

FIG. 5 is a view illustrating a first moving space and a second moving space formed in the housing;

FIG. 6 is a schematic view illustrating a state in which a bolt is supplied to the housing;

FIG. 7 is an exploded perspective view of a control module;

FIG. 8 is a view illustrating a state in which a second pin of the control module closes a portion of the second moving space formed in the housing;

FIG. 9 is a view illustrating a state in which a first pin of the control module closes a portion of the second moving space formed in the housing;

FIG. 10 is a view illustrating a state in which the first pin of the control module is disposed between the bolts;

FIG. 11 is an exploded perspective view of a fixing device;

FIG. 12 is an exploded perspective view of a receiving module;

FIG. 13 is a view illustrating a state in which the receiving module is coupled to a guide unit;

FIG. 14 is an exploded perspective view of a clamping module;

FIG. 15 is a view illustrating a state in which a third actuating assembly of the clamping module is coupled to a connecting module;

FIG. 16 is a view illustrating a state in which the receiving module of the fixing device is operated;

FIG. 17 is a view illustrating a state in which a body of the bolt is disposed in an accommodation groove of a receiving plate;

FIG. 18 is a view illustrating a state in which the clamping module is operated in a state in which the receiving module is operated; and

FIG. 19 is a view illustrating a state in which the clamping module clamps the body of the bolt.

### DETAILED DESCRIPTION OF EXEMPLARY EMBODIMENTS

The present invention may be modified in various changes and may have various embodiments, and thus specific embodiments will be illustrated and described in the accompanying drawings. However, it should be understood that the present invention is not limited to the specific embodiments and includes all changes, equivalents, and substitutions included in the spirit and scope of the present invention.

Terms including ordinal numbers such as first and second may be used to describe various components, but the components are not limited by the terms. The terms are only used to distinguish one component from another component. For example, a second component may be renamed a first component without departing from the scope of rights of the present invention, and similarly, a first component may also be renamed a second component. Term “and/or” includes any or a combination of a plurality of related listed items.

It should be understood that, when it is referenced that a first component is “connected” or “coupled” to a second component, the first component may be directly connected or coupled to the second component, or a third component may be present between the first component and the second component. On the other hand, it should be understood that, when a first component is “directly connected” or “directly coupled” to a second component, a third component is not present therebetween.

In the description of the embodiment, a case in which it is described that a first component is formed “on or under” a second component includes both a case in which the two components are in direct contact with each other and a case in which one or more other components are arranged between the two components. Further, when the term “on or under” is expressed, the term “on or under” may include the meanings of a downward direction as well as an upward direction based on one component.

Terms used in the present application are used only to describe the specific embodiments and are not intended to limit the present invention. Singular expressions include plural expressions unless clearly otherwise indicated in the context. It should be understood in the present application that terms such as “include” or “have” are intended to indicate that there are features, numbers, steps, operations, components, parts, or combinations thereof that are described in the specification and do not exclude in advance the possibility of the presence or addition of one or more other features, numbers, steps, operations, components, parts, or combinations thereof.

Unless otherwise defined, all terms used herein including technical or scientific terms have the same meanings as those commonly understood by those skilled in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a fastening assistance system will be described in detail with reference to the accompanying drawings, but same or corresponding components are designated by the same reference numerals regardless of drawing symbols, and duplicated descriptions thereof will be omitted.

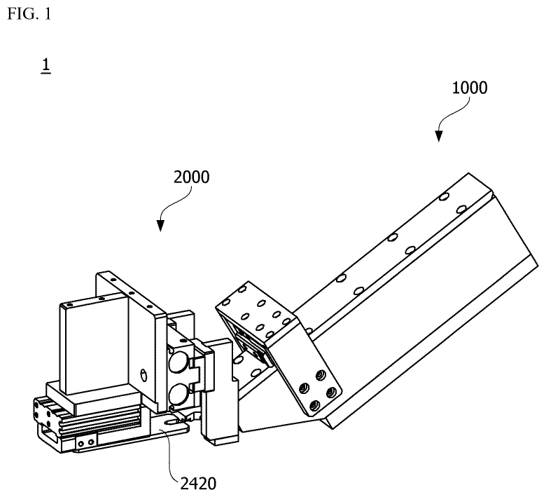

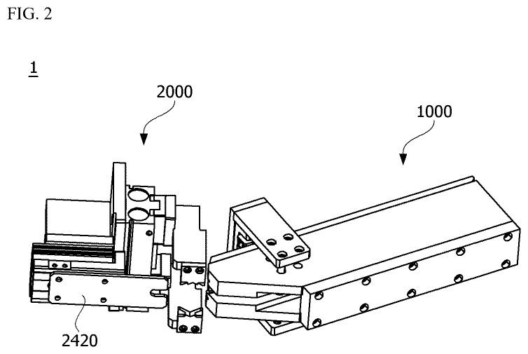

FIG. 1 is a plan perspective view of a fastening assistance system according to an embodiment of the present invention, and FIG. 2 is a bottom perspective view of the fastening assistance system according to the embodiment of the present invention.

Referring to FIGS. 1 and 2, a fastening assistance system 1 according to an embodiment of the present invention is a system that fixes a bolt B to fasten the bolt B to an object, and the fastening assistance system 1 includes an ejecting/feeding device 1000 and a fixing device 2000.

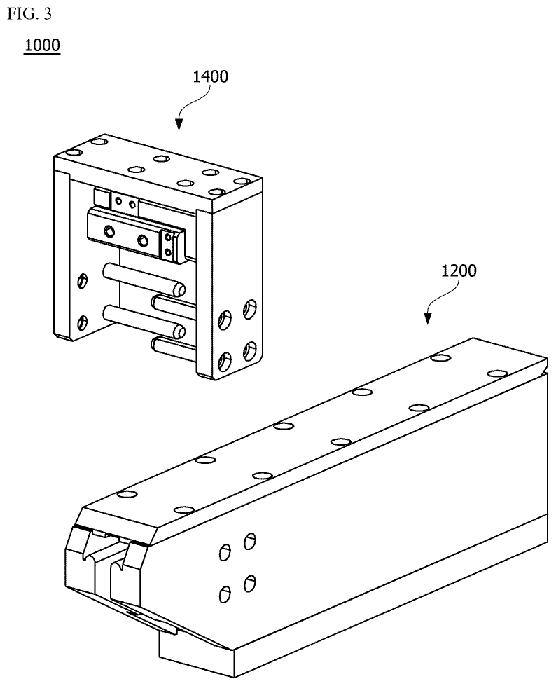

FIG. 3 is an exploded perspective view of an ejecting/feeding device.

Referring to FIGS. 1 to 3, the ejecting/feeding device 1000 may receive a plurality of bolts B from the outside and may eject the plurality of supplied bolts B to the outside. The ejecting/feeding device 1000 may include a housing 1200 and a control module 1400.

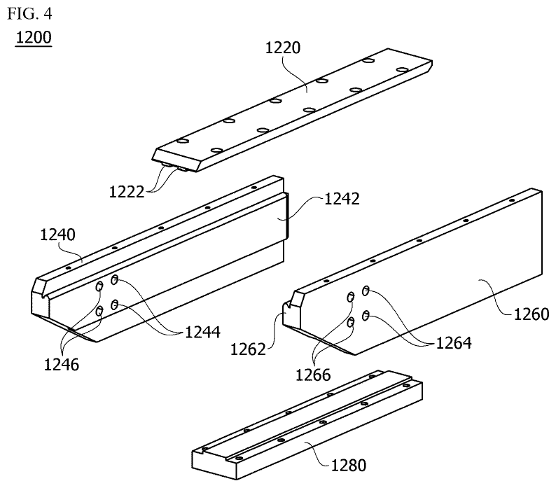

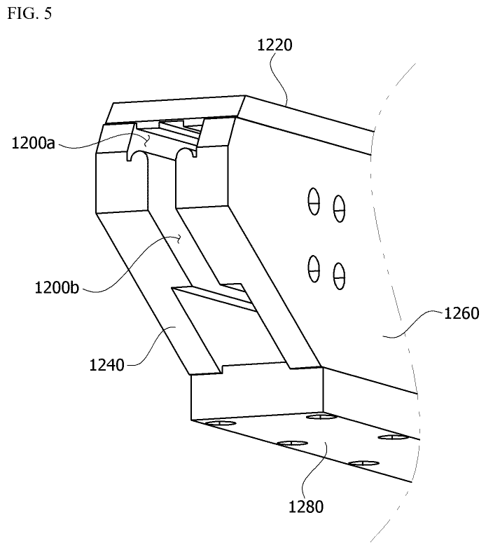

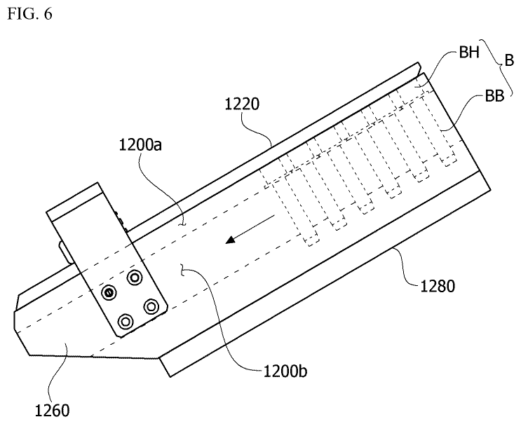

FIG. 4 is an exploded perspective view of a housing of the ejecting/feeding device, FIG. 5 is a view illustrating a first moving space and a second moving space formed in the housing, and FIG. 6 is a schematic view illustrating a state in which a bolt is supplied to the housing.

Referring to FIGS. 1 to 3, and 4 to 6, the housing 1200 may accommodate the plurality of bolts B therein and allow the plurality of bolts B accommodated therein to be arranged. The housing 1200 may include a first top plate 1220, a first side plate 1240, a second side plate 1260, and a bottom plate 1280.

The first top plate 1220 may be disposed on the first side plate 1240 and the second side plate 1260. The first top plate 1220 may close one side of a space defined by the first side plate 1240 and the second side plate 1260. Therefore, a phenomenon in which the bolt B supplied to the housing 1200 is separated from the inside of the housing 1200 to the outside may be prevented.

The first top plate 1220 may include a first protrusion 1222. The first protrusion 1222 may protrude from one surface of the first top plate 1220. The first protrusion 1222 may be disposed between the first side plate 1240 and the second side plate 1260. The first protrusion portion 1222 may suppress shaking of a head BH of the bolt B introduced into the housing 1200. Thus, the first protrusion 1222 may prevent the bolts B from colliding with each other by the shaking of the bolts B moving inside the housing 1200 and thus may prevent damage to the bolts B.

The first side plate 1240 may be disposed under the first top plate 1220. The first side plate 1240 may support the first top plate 1220. The first side plate 1240 may include a second protrusion 1242, a 1-1 accommodation hole 1244, and a 1-2 accommodation hole 1246.

The second protrusion 1242 may be disposed on one surface of the first side plate 1240. The second protrusion 1242 may protrude from one surface of the first side plate 1240 toward the second side plate 1260 disposed in parallel with the first side plate 1240. One surface of the second protrusion 1242 may have a curved shape. A portion of the second protrusion 1242 having a curved shape may be a surface that is in contact with the head BH of the bolt B introduced into the housing 1200 to guide the head BH.

The 1-1 accommodation hole 1244 may be formed through the first side plate 1240. Here, the 1-1 accommodation hole 1244 may pass through the second protrusion 1242. The 1-1 accommodation hole 1244 may be provided as a plurality of 1-1 accommodation holes 1244, and the plurality of 1-1 accommodation holes 1244 may be arranged in a direction from the first top plate 1220 toward the first side plate 1240. The 1-1 accommodation hole 1244 may accommodate a first pin 1462, which will be described below, and may support the first pin 1462.

The 1-2 accommodation hole 1246 may be formed while passing through the first side plate 1240. Here, the 1-2 accommodation hole 1246 may pass through the second protrusion 1242. The 1-2 accommodation hole 1246 may be provided as a plurality of 1-2 accommodation holes 1246, and the plurality of 1-2 accommodation holes 1246 may be arranged in the direction from the first top plate 1220 toward the first side plate 1240. The 1-2 accommodation hole 1246 may be disposed in front of the 1-1 accommodation hole 1244 in a direction in which the first side plate 1240 is disposed. The 1-2 accommodation hole 1246 may form a space in which a second pin 1464, which will be described below, may be movable.

The second side plate 1260 may be disposed under the first top plate 1220. The second side plate 1260 may support the first top plate 1220. The second side plate 1260 may be disposed in parallel with the first side plate 1240. The second side plate 1260 may have a shape symmetrical to the first side plate 1240. The second side plate 1260 may include a third protrusion 1262, a 2-1 accommodation hole 1264, and a 2-2 accommodation hole 1266.

The third protrusion 1262 may be disposed on one surface of the second side plate 1260. The third protrusion 1262 may protrude from one surface of the second side plate 1260 toward the first side plate 1240 disposed in parallel with the second side plate 1260. One surface of the third protrusion 1262 may have a curved shape. A portion of the third protrusion 1262 having a curved shape may be a surface that is in contact with the head BH of the bolt B introduced into the housing 1200 to guide the head BH.

The 2-1 accommodation hole 1264 may be formed through the second side plate 1260. Here, the 2-1 accommodation hole 1264 may pass through the third protrusion 1262. The 2-1 accommodation hole 1264 may be provided as a plurality of 2-1 accommodation holes 1264, and the plurality of 2-1 accommodation holes 1264 may be arranged in the direction from the first top plate 1220 toward the second side plate 1260. The 2-1 accommodation hole 1264 may form a space in which the first pin 1462, which will be described below, may be movable. In a state in which the second side plate 1260 is disposed in parallel with the first side plate 1240, the 2-1 accommodation hole 1264 may be disposed at a location facing the 1-1 accommodation hole 1244 of the first side plate 1240.

The 2-2 accommodation hole 1266 may be formed through the second side plate 1260. Here, the 2-2 accommodation hole 1266 may pass through the third protrusion 1262. The 2-2 accommodation hole 1266 may be provided as a plurality of 2-2 accommodation holes 1266, and the plurality of 2-2 accommodation holes 1266 may be arranged in the direction from the first top plate 1220 toward the second side plate 1260. The 2-2 accommodation hole 1266 may be disposed in front of the 2-1 accommodation hole 1264 in a direction in which the second side plate 1260 is disposed. The 2-2 accommodation hole 1266 may accommodate the second pin 1464, which will be described below, and may support the second pin 1464. In a state in which the second side plate 1260 is disposed in parallel with the first side plate 1240, the 2-2 accommodation hole 1266 may be disposed at a location facing the 1-2 accommodation hole 1246 of the first side plate 1240.

The bottom plate 1280 may be disposed to face the first top plate 1220. The bottom plate 1280 may be spaced apart from the first top plate 1220. The bottom plate 1280 may support the first side plate 1240 and the second side plate 1260. Thus, the bottom plate 1280 may close a portion of the space defined by the first side plate 1240 and the second side plate 1260.

Referring to FIGS. 3 and 4, an end portion of the first side plate 1240 and the second side plate 1260 through which the bolt B is ejected may have a cut edge shape. This may be to prevent an ejection delay that is caused by a body BB hitting the housing 1200 when the bolt B is ejected to the outside of the housing 1200.

Referring to FIGS. 5 and 6, a first moving space 1200a in which the head BH of the bolt B is moved and a second moving space 1200b which is connected to the first moving space 1200a and in which the body BB of the bolt B is moved may be formed in the housing 1200 of the ejecting/feeding device 1000. That is, a moving space having a “T” shape may be formed between the first side plate 1240 and the second side plate 1260 through the second protrusion 1242 of the first side plate 1240 and the third protrusion 1262 of the second side plate 1260. This is to prevent a phenomenon in which the bolt B hits the housing 1200 or the bolt B and the bolt B hit each other during the movement of the bolt B by suppressing the shaking of the bolt B moving inside the housing 1200.

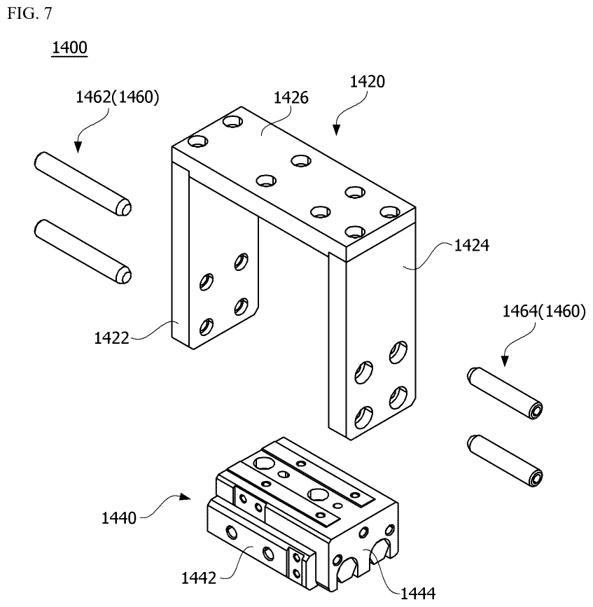

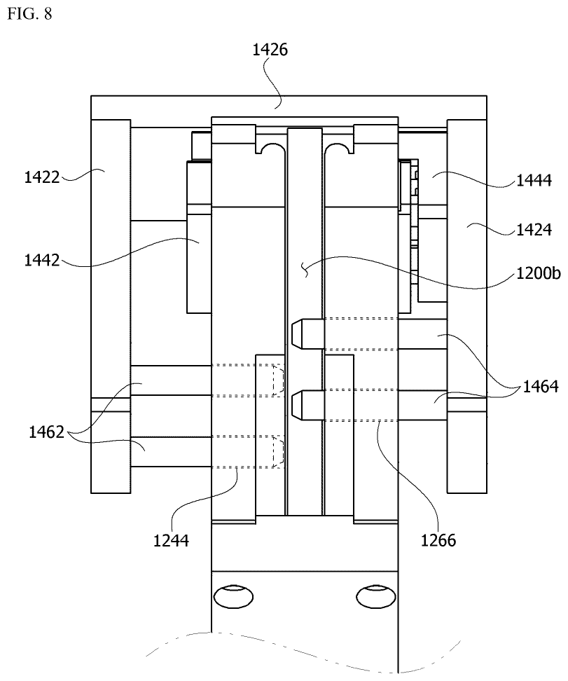

FIG. 7 is an exploded perspective view of a control module, and FIG. 8 is a view illustrating a state in which a second pin of the control module closes a portion of the second moving space formed in the housing.

Referring to FIGS. 1, 2, 7 and 8, the control module 1400 may control movement amounts of the plurality of bolts B so that the plurality of bolts B may be ejected. The control module 1400 may include a guide unit 1420, a first actuating assembly 1440, and a pin unit 1460.

The guide unit 1420 may be coupled to the pin unit 1460 to guide a movement direction of the pin unit 1460. The guide unit 1420 includes a combination of a third side plate 1422, a fourth side plate 1424, and a second top plate 1426.

The third side plate 1422 may support the first pin 1462, which will be described below. The fourth side plate 1424 may be disposed in parallel with the third side plate 1422 and may support the second pin 1464, which will be described below. The second top plate 1426 may connect the third side plate 1422 and the fourth side plate 1424 and may be coupled to the first actuating assembly 1440, which will be described below.

The first actuating assembly 1440 may be supported by the housing 1200 and move the guide unit 1420. The first actuating assembly 1440 may include a first actuator 1442 and a first moving block 1444.

The first actuator 1442 may be disposed on the first top plate 1220 of the housing 1200. The first actuator 1442 may be operated by receiving or charging power from the outside and may generate power.

The first moving block 1444 may be connected to the first actuator 1442. The first moving block 1444 may be coupled to the second top plate 1426 of the guide unit 1420 and support the second top plate 1426. The first moving block 1444 may be moved through the power generated by the first actuator 1442. The first moving block 1444 may be linearly moved and may be moved in a leftward direction or a rightward direction with respect to FIG. 8. When the first moving block 1444 is moved, the second top plate 1426 coupled to the first moving block 1444 may be moved. That is, the first moving block 1444 may linearly move the guide unit 1420. Here, the first moving block 1444 may have a shape bent once to stably move the guide unit 1420 while being connected to the first actuator 1442, but the present invention is not limited thereto.

The pin unit 1460 may separate the bolt B disposed at the frontmost bolt B of the plurality of bolts B accommodated in the housing 1200 from the plurality of remaining bolts B. The pin unit 1460 may include the first pin 1462 and the second pin 1464. In this way, the pin unit 1460 including the first pin 1462 and the second pin 1464 may be disposed at a location passing through the housing 1200.

The first pin 1462 may be coupled to the third side plate 1422 of the guide unit 1420. The first pin 1462 may be provided as a plurality of first pins 1462, and the plurality of first pins 1462 may be arranged in a direction in which the 1-1 accommodation hole 1244 or the 1-2 accommodation hole 1246 of the first side plate 1240 of the housing 1200 is disposed. Further, the plurality of first pins 1462 may be arranged in a direction from the first side plate 1240 toward the second side plate 1260 of the housing 1200. The first pin 1462 may be movably accommodated in the 1-1 accommodation hole 1244 of the first side plate 1240 of the housing 1200 while being coupled to the third side plate 1422.

The second pin 1464 may be coupled to the fourth side plate 1424 of the guide unit 1420. The second pin 1464 may be provided as a plurality of second pins 1464, and the plurality of second pins 1464 may be arranged in a direction in which the 2-1 accommodation hole 1264 or the 2-2 accommodation hole 1266 of the second side plate 1260 of the housing 1200 is disposed. Further, the plurality of second pins 1464 may be arranged in a direction from the second side plate 1260 toward the first side plate 1240 of the housing 1200. The second pin 1464 may be movably accommodated in the 2-2 accommodation hole 1266 of the second side plate 1260 of the housing 1200 while being coupled to the fourth side plate 1424.

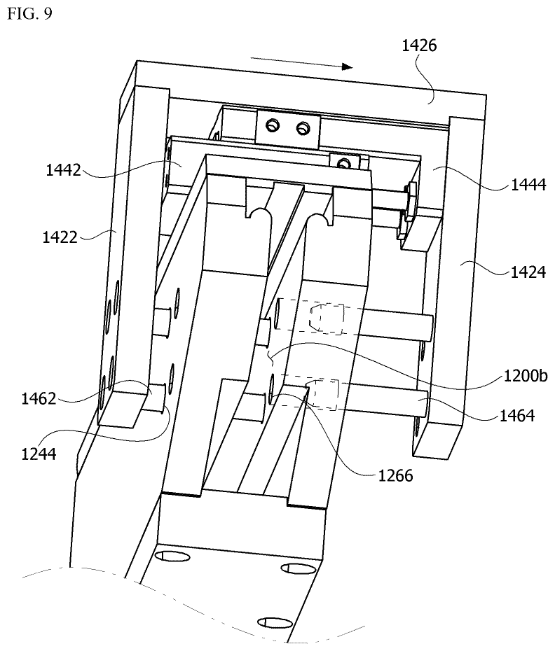

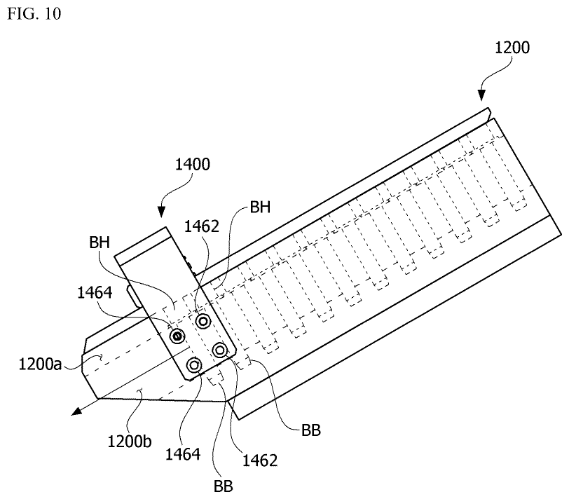

FIG. 9 is a view illustrating a state in which a first pin of the control module closes a portion of the second moving space formed in the housing, and FIG. 10 is a view illustrating a state in which the first pin of the control module is disposed between the bolts.

Referring to FIGS. 8 and 10, the first pin 1462 may prevent movement of the plurality of remaining bolts B except for the frontmost bolt B of the plurality of bolts B arranged inside the housing 1200. In more detail, when the first actuator 1442 of the control module 1400 is operated, the guide unit 1420 and the first moving block 1444 of the first actuating assembly 1440 supporting the guide unit 1420 may be arranged at a first location. Here, the second pin 1464 coupled to the fourth side plate 1424 of the guide unit 1420 closes a portion of the second moving space 1200b formed in the housing 1200 by the guide unit 1420 and the first moving block 1444 arranged at the first location (see FIG. 8).

Accordingly, the first pin 1462 is disposed at a location at which the first pin 1462 crosses the second moving space 1200b formed inside the housing 1200. Thus, the bolt B accommodated inside the housing 1200 cannot be ejected to the outside of the housing 1200 while being maintained in contact with the second pin 1464. Thus, the bolt B introduced into the housing 1200 may be moved to be in contact with the second pin 1464.

In contrast, in a state in which the second pin 1464 closes the portion of the second moving space 1200b formed in the housing 1200, when the first actuator 1442 of the control module 1400 is operated, the guide unit 1420 and the first moving block 1444 of the first actuating assembly 1440 supporting the guide unit 1420 may be moved from the first location to be disposed at a second location. Here, the first pin 1462 coupled to the third side plate 1422 of the guide unit 1420 closes the portion of the second moving space 1200b formed in the housing 1200 by the guide unit 1420 and the first moving block 1444 arranged at the second location (see FIG. 9).

Further, the second pin 1464 is disposed at a location at which the second pin 1464 does not close the portion of the second moving space 1200b formed in the housing 1200. That is, movement blocking of the bolt B in contact with the second pin 1464 is released, and thus, the bolt B is ejected to the outside of the housing 1200.

In this way, the first pin 1462 may be in contact with the body BB of the bolt B moving in the second moving space 1200b of the housing 1200 to prevent the movement of the bolt B. This may prevent a phenomenon in which the bolts B are unintentionally ejected by preventing the movement of the plurality of bolts B moving inside the housing 1200 without a power source. Further, because the first pin 1462 does not close the portion of the second moving space 1200b formed in the housing 1200, the movement of the bolts B introduced into the housing 1200 may be induced so that the plurality of bolts 1B may be introduced into the housing 1200.

Further, referring to FIGS. 9 and 10, the second pin 1464 may be disposed in front of the first pin 1462 in a direction in which the bolt B is moved, and the movement of the bolt B separated from the plurality of bolts B may be controlled by the first pin 1462. As described above, the second pin 1464 may be moved together with the fourth side plate 1424 of the guide unit 1420. Thus, the frontmost bolt B of the bolts B introduced into the housing 1200 may be moved by the second pin 1464. Further, a phenomenon in which the bolt B is ejected while the fastening assistance system 1 of the present invention is not placed at a location at which the bolt B is fastened may be prevented.

Further, referring to FIGS. 9 and 10, the first pin 1462 and the second pin 1464 of the pin unit 1460 may be simultaneously moved by the first actuating assembly 1440 while being supported by the guide unit 1420. Further, the pin unit 1460 may be movable in the second moving space 1200b formed in the housing 1200. As illustrated in FIG. 10, this is to separate the frontmost bolt B of the plurality of bolts B accommodated inside the housing 1200 from the remaining bolts B.

In more detail, when the first actuator 1442 of the control module 1400 is operated and the first moving block 1444 is moved to the right side, the guide unit 1420 coupled to the first moving block 1444 and the first pin 1462 supported by the third side plate 1422 of the guide unit 1420 are moved to the right side along the first moving block 1444 (see FIG. 9). Accordingly, the first pin 1462 is disposed at a location at which the first pin 1462 crosses the second moving space 1200b formed inside the housing 1200. In this case, as illustrated in FIG. 10, the first pin 1462 moved in the second moving space 1200b of the housing 1200 is disposed between the frontmost bolt B of the plurality of bolts B and the body BB of the bolt B, which is disposed consecutively with the body BB of the frontmost bolt B.

Accordingly, the frontmost bolt B of the plurality of bolts B accommodated in the housing 1200 may be separated from the remaining bolts B (see FIG. 10). In this case, when the first pin 1462 is moved together with the guide unit 1420, the second pin 1464 also is moved together with the guide unit 1420, and thus the second pin 1464 is disposed at a location at which the second pin 1464 opens the second moving space 1200b formed in the housing 1200. Thus, the bolt B separated from the plurality of bolts B by the first pin 1462 may be moved to be ejected to the outside of the housing 1200.

In this way, the fastening assistance system 1 according to the embodiment of the present invention may individually separate and eject the plurality of bolts B arranged inside the housing 1200.

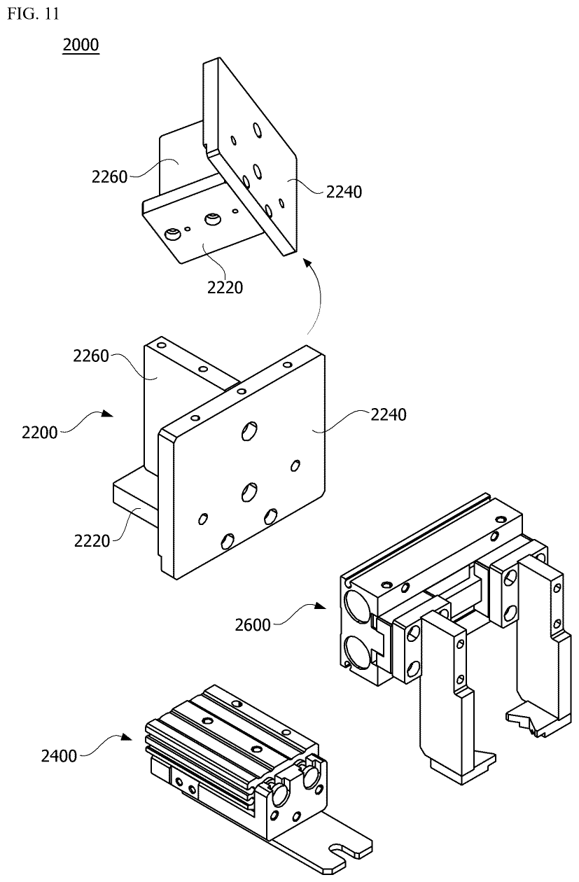

FIG. 11 is an exploded perspective view of a fixing device.

Referring to FIGS. 1, 2, and 11, the fixing device 2000 may fix the bolt B ejected from the ejecting/feeding device 1000. The fixing device 2000 may include a connecting module 2200, a receiving module 2400, and a holding module 2600.

The connecting module 2200 may be coupled to the receiving module 2400 and the holding module 2600 to support each of the receiving module 2400 and the holding module 2600. The connecting module 2200 may include a first connecting block 2220 supporting the receiving module 2400, a second connecting block 2240 supporting the holding module 2600, and a third connecting block 2260 connected to the first connecting block 2220 and the second connecting block 2240 to support the first connecting block 2220 and the second connecting block 2240. Here, the first connecting block 2220 and the second connecting block 2240 may be arranged in directions vertically intersecting each other.

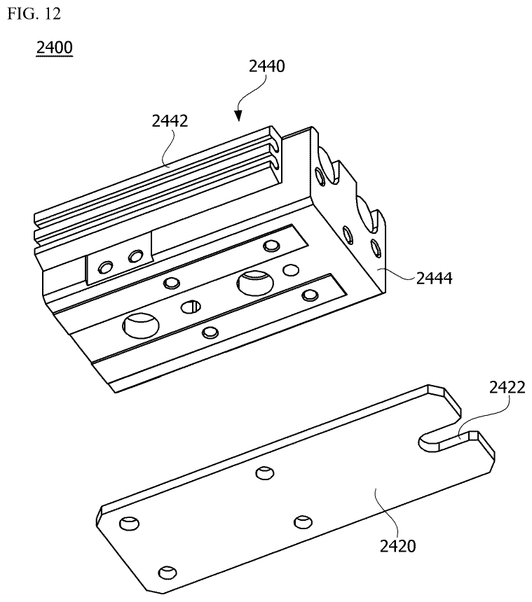

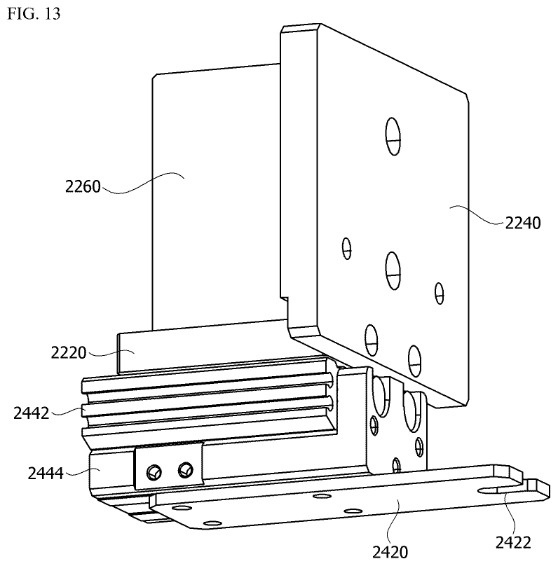

FIG. 12 is an exploded perspective view of a receiving module, and FIG. 13 is a view illustrating a state in which the receiving module is coupled to a guide unit.

Referring to FIGS. 1, 2, 11, 12, and 13, the receiving module 2400 may accommodate the bolt B ejected through the control module 1400 of the ejecting/feeding device 1000. The receiving module 2400 may include a receiving plate 2420 and a second actuating assembly 2440.

The receiving plate 2420 may be connected to the second actuating assembly 2440 and moved toward the ejecting/feeding device 1000 or away from the ejecting/feeding device 1000 in conjunction with an operation of the second actuating assembly 2440.

Further, the receiving plate 2420 may support the bolt B ejected to the outside of the housing 1200 of the ejecting/feeding device 1000. In more detail, the receiving plate 2420 may include an accommodation groove 2422. The accommodation groove 2422 may be formed in an area of the receiving plate 2420, which is close to the ejecting/feeding device 1000. A width of the accommodation groove 2422 may be greater than or equal to a diameter of the body BB of the bolt B. The accommodation groove 2422 may accommodate the body BB of the bolt B ejected to the outside of the ejecting/feeding device 1000.

The second actuating assembly 2440 may move the receiving plate 2420. The second actuating assembly 2440 may include a second actuator 2442 and a second moving block 2444.

The second actuator 2442 may be coupled to the first connecting block 2220 of the connecting module 2200. Thus, the second actuator 2442 may be supported by the first connecting block 2220. The second actuator 2442 may be operated by receiving or charging power from the outside and may generate power.

The second moving block 2444 may be connected to the second actuator 2442. The second moving block 2444 may be moved toward the ejecting/feeding device 1000 or moved away from the ejecting/feeding device 1000 by the power generated by the second actuator 2442. Further, the second moving block 2444 may be coupled to the receiving plate 2420 to support the receiving plate 2420. Thus, when the second moving block 2444 is moved by the second actuator 2442, the receiving plate 2420 may be moved along the second moving block 2444. That is, the second moving block 2444 may linearly move the receiving plate 2420. Here, the first moving block 1444 may have a shape bent once to stably move the guide unit 1420 while being connected to the second actuator 2442, but the present invention is not limited thereto.

Referring to FIG. 1, the ejecting/feeding device 1000 may be disposed to be inclined with respect to a movement direction of the receiving plate 2420. This is to allow the bolt B ejected from the ejecting/feeding device 1000 to be disposed perpendicular to an object.

Further, the fact that the ejecting/feeding device 1000 is disposed to be inclined with respect to the movement direction of the receiving plate 2420 is to allow the bolt B ejected from the ejecting/feeding device 100 to be ejected from the housing 1200 without power. Thus, because the need for a separate device to move the bolt B inside the housing 1200 is eliminated, costs for manufacturing and operating the fastening assistance system 1 may be reduced.

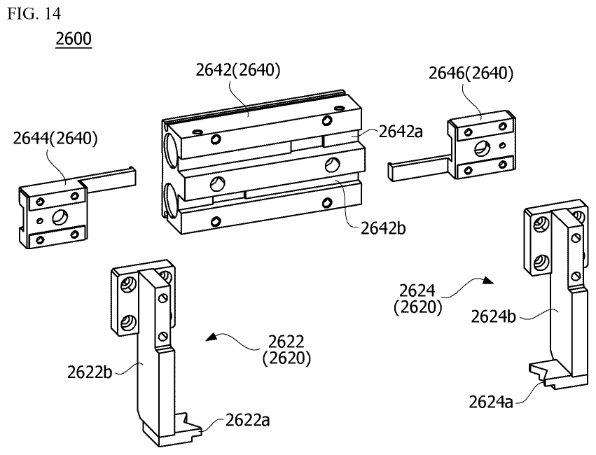

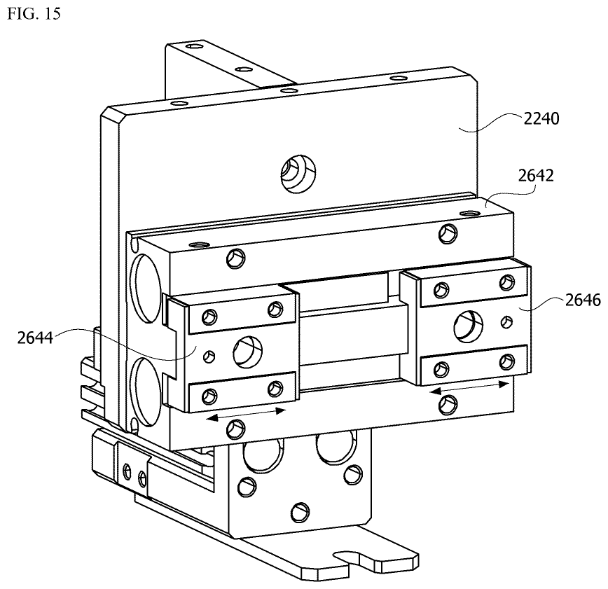

FIG. 14 is an exploded perspective view of a clamping module, and FIG. 15 is a view illustrating a state in which a third actuating assembly of the clamping module is coupled to a connecting module.

Referring to FIGS. 1, 2, 11, 14 and 15, the holding module 2600 may hold the bolt B seated on the receiving module 2400. The receiving module 2400 may include a clamping module 2620 and a third actuating assembly 2640.

The clamping module 2620 may clamp the bolt B seated on the receiving plate 2420 of the receiving module 2400. The clamping module 2620 may include a first biting assembly 2622 and a second biting assembly 2624.

The first biting assembly 2622 and the second biting assembly 2624 may have shapes symmetrical to each other. Further, the first biting assembly 2622 and the second biting assembly 2624 may be moved in a direction close to or away from each other through the third actuating assembly 2640.

The first biting assembly 2622 may include a first biting block 2622a that clamps the bolt B seated on the accommodation groove 2422 of the receiving plate 2420 and a first support block 2622b that is coupled to the first biting block 2622a, supports the first biting block 2622a, and is connected to the third actuating assembly 2640. Here, the first biting block 2622a and the first support block 2622b may be integrally formed.

The second biting assembly 2624 may include a second biting block 2624a that clamps the bolt B seated on the accommodation groove 2422 of the receiving plate 2420 and a second support block 2624b that is coupled to the second biting block 2624a, supports the second biting block 2624a, and is connected to the third actuating assembly 2640. Here, the second biting block 2624a and the second support block 2624b may be integrally formed.

The third actuating assembly 2640 may move the first biting block 2622a and the second biting block 2624a of the clamping module 2620 in different directions. The third actuating assembly 2640 may include a third actuator 2642, a 3-1 moving block 2644, and a 3-2 moving block 2646.

The third actuator 2642 may be coupled to the second connecting block 2240 of the connecting module 2200 (see FIG. 15). Thus, the third actuator 2642 may be supported by the second connecting block 2240. The third actuator 2642 may be operated by receiving or charging power from the outside and may generate power.

The third actuator 2642 may include a first rail groove 2642a and a second rail groove 2642b. The first rail groove 2642a and the second rail groove 2642b may be arranged in a vertical direction based on FIG. 15. The first rail groove 2642a and the second rail groove 2642b may guide movement directions of the 3-1 moving block 2644 and the 3-2 moving block 2646.

The 3-1 moving block 2644 may be coupled to the first support block 2622b of the first biting assembly 2622. Further, the 3-1 moving block 2644 may be connected to the third actuator 2642 and moved by the power generated by the third actuator 2642. In this case, the 3-1 moving block 2644 may be movably disposed in the first rail groove 2642a and the second rail groove 2642b of the third actuator 2642. Thus, the 3-1 moving block 2644 may be moved along the first rail groove 2642a and the second rail groove 2642b.

The 3-2 moving block 2646 may be coupled to the second support block 2624b of the second biting assembly 2624. Further, the 3-2 moving block 2646 may be connected to the third actuator 2642 and moved by the power generated by the third actuator 2642. In this case, the 3-2 moving block 2646 may be movably disposed in the first rail groove 2642a and the second rail groove 2642b of the third actuator 2642. Thus, the 3-2 moving block 2646 may be moved along the first rail groove 2642a and the second rail groove 2642b. Here, the 3-2 moving block 2646 may be moved in a direction opposite to the 3-1 moving block 2644 by the power generated by the third actuator 2642. That is, the 3-2 moving block 2646 may be moved to approach the 3-1 moving block 2644 or may be linearly moved away from the 3-1 moving block 2644. Hereinafter, a process of fixing the bolt B to be fastened to an object through the fastening assistance system 1 will be described.

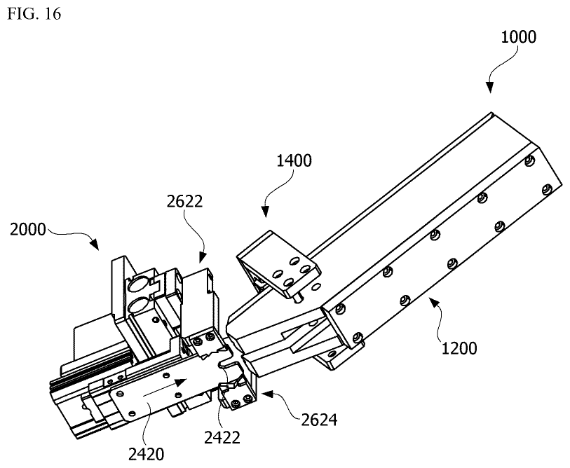

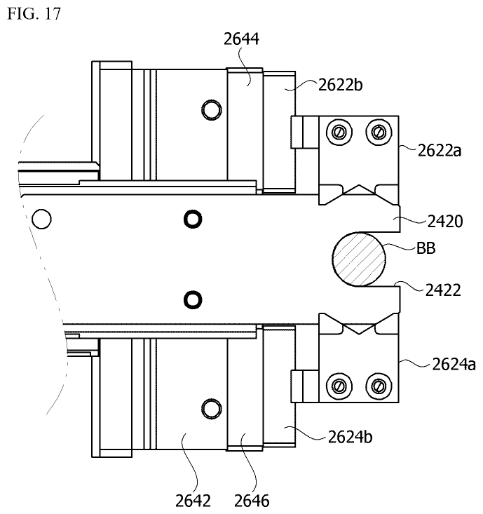

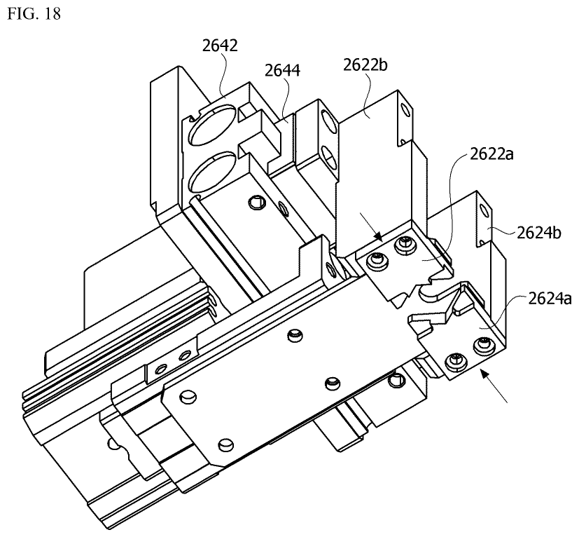

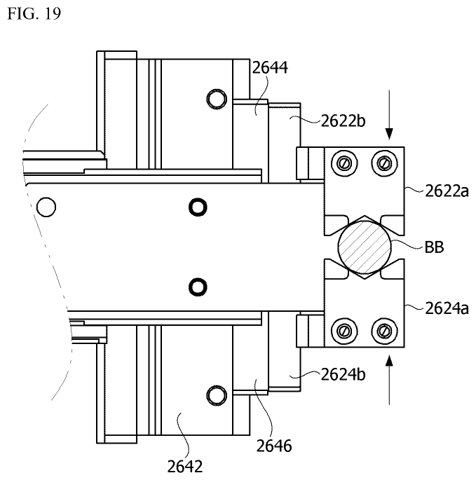

FIG. 16 is a view illustrating a state in which the receiving module of the fixing device is operated, FIG. 17 is a view illustrating a state in which a body of the bolt is disposed in an accommodation groove of receiving plate, FIG. 18 is a view illustrating a state in which the clamping module is operated in a state in which the receiving module is operated, and FIG. 19 is a view illustrating a state in which the clamping module clamps the body of the bolt.

Referring to FIGS. 1 to 19, more specifically, referring to FIGS. 16 to 19, first, in a state in which the bolt B is not supplied into the housing 1200, the second pin 1464 of the control module 1400 of the ejecting/feeding device 1000 is disposed at a location at which the second pin 1464 crosses a second space formed inside the housing 1200 (see FIG. 8). Further, in this state, the first pin 1462 of the control module 1400 of the ejecting/feeding device 1000 is not disposed in the second moving space 1200b of the housing 1200 (see FIG. 8).

In this state, the receiving module 2400 of the fixing device 2000 is operated. In more detail, the second actuator 2442 of the receiving module 2400 is operated, and the second moving block 2444 and the receiving plate 2420 connected to the second moving block 2444 are moved to approach the ejecting/feeding device 1000 by the second actuator 2442.

Thus, as illustrated in FIGS. 16 and 17, the receiving plate 2420 is disposed between the first biting assembly 2622 and the second biting assembly 2624 of the holding module 2600 of the fixing device 2000. In more detail, the receiving plate 2420 is disposed between the first biting assembly 2622 and the second biting assembly 2624 so that a center of the accommodation groove 2422 of the receiving plate 2420, a center of the first biting block 2622a, and a center of the second biting block 2624a coincide with one another.

In the above state, the bolt B is supplied into the housing 1200. A space that may accommodate the plurality of bolts B is formed inside the housing 1200, and the bolt B introduced into the housing 1200 is moved through the first moving space 1200a and the second moving space 1200b. Here, since the housing 1200 is arranged to be inclined in the receiving plate 2420 of the receiving module 2400 of the fixing device 2000, the bolt B introduced into the housing 1200 is moved inside the housing 1200 without special power supply due to the gravity, and then the plurality of bolts B are aligned inside the housing 1200 (see FIG. 10).

In this way, in a state in which the plurality of bolts B are introduced into and aligned inside the housing 1200, when the first actuator 1442 of the control module 1400 of the ejecting/feeding device 1000 is operated, the first moving block 1444 connected to the first actuator 1442 is moved as illustrated in FIG. 9, and the guide unit 1420 of the control module 1400 connected to the first moving block 1444 is moved along the first moving block 1444. Accordingly, the first pin 1462 and the second pin 1464 connected to the guide unit 1420 are also moved along the guide unit 1420. Here, as illustrated in FIG. 9, the second pin 1464 of the control module 1400 is moved to open the second moving space 1200b formed in the housing 1200, and the first pin 1462 is moved to cross the second moving space 1200b formed in the housing 1200. Thus, the frontmost bolt B of the plurality of bolts B accommodated in the housing 1200 is moved to be ejected to the outside of the housing 1200, and the movement of the remaining bolts B except for the frontmost bolt B is prevented by the first pin 1462.

The bolt B, which is moved to be ejected to the outside of the housing 1200 through the above processes, is seated on the receiving plate 2420. In more detail, as illustrated in FIG. 17, the body BB of the bolt B is disposed in the accommodating groove 2422 of the receiving plate 2420.

When the bolt B is seated on the receiving plate 2420, the third actuator 2642 of the third actuating assembly 2640 of the holding module 2600 is operated. When the third actuator 2642 is operated, the 3-1 moving block 2644 and the 3-2 moving block 2646 connected to the third actuator 2642 are moved. In more detail, the 3-1 moving block 2644 and the 3-2 moving block 2646 are moved in a direction in which the 3-1 moving block 2644 and the 3-2 moving block 2646 are arranged close to each other. Accordingly, the first biting assembly 2622 connected to the 3-1 moving block 2644 and the second biting assembly 2624 connected to the 3-2 moving block 2646 are moved to approach each other.

Thus, as illustrated in FIG. 19, the first biting block 2622a of the first biting assembly 2622 and the second biting block 2624a of the second biting assembly 2624 clamp the body BB of the bolt B. Accordingly, the bolt B is fixed.

In this way, the fastening assistance system 1 according to the embodiment of the present invention may arrange the bolt B at a location for the bolt B to be fastened to an object, fix the bolt B at the location for the bolt B to be coupled to the object, and then suppress the shaking of the bolt B. Thus, coupling stability between the object and the bolt B can be improved.

According to an embodiment of the present invention, a system that individually supplies bolts without power and fixes the individually supplied bolts without shaking is disclosed, and thus stable fastening between an object and the bolts may be possible.

Although the embodiments of the present invention have been described above, those skilled in the art may understand that the present invention may be variously modified and changed without departing from the spirit and scope of the present invention described in the appended claims. Further, differences related to these changes and modifications should be construed as being included in the scope of the present invention defined in the appended claims.

What is claimed is:

1. A fastening assistance system comprising:
an ejecting/feeding device configured to receive a plurality of bolts from an outside and eject the plurality of received bolts to the outside; and
a fixing device configured to fix the bolts ejected from the ejecting/feeding device,
wherein the ejecting/feeding device includes a control module configured to control movement of the plurality of bolts so that the plurality of bolts are individually ejected.

2. The fastening assistance system of claim 1, wherein the ejecting/feeding device includes a housing configured to accommodate the plurality of bolts therein and arrange the plurality of bolts accommodated therein, and
the control module includes a pin unit configured to separate a frontmost bolt of the plurality of bolts accommodated in the housing from the plurality of remaining bolts.

3. The fastening assistance system of claim 2, wherein the pin unit is disposed at a location at which the pin unit passes through the housing.

4. The fastening assistance system of claim 2, wherein a first moving space, in which a head of a bolt is moved, and a second moving space, which is connected to the first moving space and in which a body of a bolt is moved, are formed in the housing of the ejecting/feeding device, and
the pin unit is movable in the second moving space.

5. The fastening assistance system of claim 2, wherein the pin unit of the control module includes a first pin configured to prevent movement of the plurality of remaining bolts except for the frontmost bolt of the plurality of bolts arranged in the housing.

6. The fastening assistance system of claim 5, wherein the pin unit of the control module includes a second pin disposed in front of the first pin in a direction in which the bolt is moved and configured to control movement of the frontmost bolt separated from the plurality of bolts by the first pin.

7. The fastening assistance system of claim 6, wherein the control module includes:
a guide unit coupled to the pin unit and configured to guide a movement direction of the pin unit; and
a first actuating assembly supported by the housing and configured to move the guide unit, and
the first pin and the second pin of the pin unit simultaneously are moved by the first actuating assembly while being supported by the guide unit.

8. The fastening assistance system of claim 2, wherein the fixing device includes:
a receiving module configured to accommodate a bolt ejected through the control module of the ejecting/feeding device; and
a holding module configured to hold the bolt seated on the receiving module.

9. The fastening assistance system of claim 8, wherein the receiving module includes:
a receiving plate configured to support the bolt ejected to the outside of the housing of the ejecting/feeding device; and
a second actuating assembly configured to move the receiving plate, and
the ejecting/feeding device is disposed to be inclined in a movement direction of the receiving plate.

10. The fastening assistance system of claim 9, wherein the holding module of the fixing device includes:
a clamping module including a first biting block and a second biting block configured to clamp the bolt seated on the receiving plate of the receiving module; and
a third actuating assembly configured to move the first biting block and the second biting block of the clamping module in different directions.
